(19) United States
(12) Patent Application Publication
(10) Pub. No.: US 2023/0153854 A1
(43) Pub. Date: May 18, 2023

(54) Beacon-Activated Automatic Generation of Scan Targets and Scan Responses

(71) Applicant: SOCKET MOBILE, INC., Fremont, CA (US)

(72) Inventors: Vincent J. COLI, Mountain View, CA (US); Leonard OTT, Livermore, CA (US)

(21) Appl. No.: 17/970,380

(22) Filed: Oct. 20, 2022

Related U.S. Application Data
(63) Continuation of application No. 16/069,859, filed on Jul. 12, 2018.
(60) Provisional application No. 62/279,827, filed on Jan. 17, 2016.

(51) Int. Cl. G06Q 30/0226; G06K 7/10; G06K 19/06; H04W 4/00; H04W 4/80; G06Q 20/32; G06Q 20/20; G06K 7/14; G06Q 30/0241

(52) U.S. Cl. CPC G06Q 30/0226; G06K 7/1095; G06K 19/06; H04W 4/00; H04W 4/80; G06Q 20/3278; G06Q 20/3274; G06Q 20/204; G06K 7/10297; G06K 7/1417; G06Q 30/0241; H04W 4/20

(57) ABSTRACT

In contexts such as in-store customer transactions, a first party operates a terminal comprising a Beacon, an NFC-Engine, and optionally an Optical Scan Engine. A Beacon payload comprising particular data activates a corresponding pre-installed software application on an in-range second party's mobile device. The activated application prepares a customized scan target for subsequent presentation at the terminal. The scan target is a dynamically generated NFC tag, QR Code, or other scan target. The scan target comprises data derived from one or more of location context provided by the Beacon payload, second party ID, and second party transaction guidance. The second party confirms the transaction by presenting their mobile device at the terminal. Optionally, the application prepares a customized payload, broadcast by the mobile device and observed by the terminal prior to the second party's arrival, to optimally configure terminal operation for an upcoming transaction.

### CROSS REFERENCE TO RELATED APPLICATIONS

Priority benefit claims for this application are made in the accompanying Application Data Sheet. This application incorporates by reference for all purposes the following application(s), all commonly owned with the instant application not later than the effective filing date of the instant application:
U.S. Non-Provisional application Ser. No. 16/069,859 (Docket No. SC-15-01US), filed Jul. 12, 2018, first named inventor Vincent J. Coli, and entitled Beacon-Activated Automatic Generation of Scan Targets and Scan Responses;
PCT Application Serial No. PCT/IB2017/050172 (Docket No. SC-15-01PCT), filed Jan. 13, 2017, first named inventor Vincent J. Coli, and entitled Beacon-Activated Automatic Generation of Scan Targets and Scan Responses; and
U.S. Provisional Application Ser. No. 62/279,827 (Docket No. SC-2015-01), filed Jan. 17, 2016, first named inventor Vincent J. Coli, and entitled Beacon-Activated Automatic Generation of Scan Targets and Scan Responses.

### BACKGROUND

Field: Advancements in in-store customer transaction technology are needed to provide improvements in cost, profitability, performance, efficiency, and utility of use.

Related Art: Unless expressly identified as being publicly or well known, mention herein of techniques and concepts, including for context, definitions, or comparison purposes, should not be construed as an admission that such techniques and concepts are previously publicly known or otherwise part of the prior art. All references cited herein (if any), including patents, patent applications, and publications, are hereby incorporated by reference in their entireties, whether specifically incorporated or not, for all purposes.

Small businesses need to offer in-store personalized customer loyalty experiences to be competitive with larger businesses and thereby retain and expand their customer base. Small business in-store customer transaction technology offerings need to do a better job of taking into account customer motivations and expectations over a wide range of situations.

### SYNOPSIS

The invention may be implemented in numerous ways, e.g. as a process, an article of manufacture, an apparatus, a system, a composition of matter, and a computer readable medium such as a computer readable storage medium (e.g., media in an optical and/or magnetic mass storage device such as a disk, an integrated circuit having non-volatile storage such as flash storage), or a computer network wherein program instructions are sent over optical or electronic communication links. The Detailed Description provides an exposition of one or more embodiments of the invention that enable improvements in cost, profitability, performance, efficiency, and utility of use in the field identified above. The Detailed Description includes an Introduction to facilitate understanding of the remainder of the Detailed Description. The Introduction includes Example Embodiments of one or more of systems, methods, articles of manufacture, and computer readable media in accordance with concepts described herein. As is discussed in more detail in the Conclusions, the invention encompasses all possible modifications and variations within the scope of the issued claims.

In contexts such as in-store customer transactions, a first party operates a terminal comprising a Beacon, an NFC-Engine, and optionally an Optical Scan Engine. A Beacon payload comprising particular data activates a corresponding pre-installed software application on an in-range second party's mobile device. The activated application prepares a customized scan target for subsequent presentation at the terminal. The scan target is a dynamically generated NFC tag, QR Code, or other scan target. The scan target comprises data derived from one or more of location context provided by the Beacon payload, second party ID, and second party transaction guidance. The second party confirms the transaction by presenting their mobile device at the terminal. Optionally, the application prepares a customized payload, broadcast by the mobile device and observed by the terminal prior to the second party's arrival at the terminal, to optimally configure terminal operation for an upcoming transaction.

### BRIEF DESCRIPTION OF DRAWINGS

FIG. 1 illustrates, via a structural perspective, embodiments for the beacon-activated automatic generation of scan targets and scan responses.

FIG. 2 illustrates, via a temporal perspective, activities, states, and interrelationships between various components of the system of FIG. 1.

### LIST OF REFERENCE SYMBOLS IN DRAWINGS

| Ref. Symbol | Element Name |
|---|---|
| 1000 | System |
| 1100 | Terminal |
| 1110 | Optical Scan Zone |
| 1120 | NFC Tap Zone |
| 1130 | Surface |
| 1140 | External Power |
| 1200 | Terminal Stand |
| 1210 | Base |
| 1211 | NFC-Engine (of Base 1210) |
| 1213 | Beacon-Engine |
| 1214 | PWR-SS (Power Subsystem) |
| 1215 | Battery |
| 1220 | Support Member(s) |
| 1221 | BLE-Radio (of NFC-Engine 1211) |
| 1221A | Antenna (in Base 1210, coupled to BLE-Radio 1221) |
| 1221N | Antenna (near top of Support Member(s) 1220, coupled to |
| | BLE-Radio 1221) |
| 1223 | BLE-Radio (of Beacon-Engine 1213) |
| 1225 | Display (coupled to Display I/F 1233) |
| 1230 | Shared-SS (Shared Subsystem) |
| 1231 | Status UI |
| 1232 | NVM |
| 1233 | Display I/F |
| 1234 | USB I/O |
| 1240 | Scanner Perch |
| 1300 | Scanner |
| 1310 | Optical Scan Engine |
| 1320 | Radio-SS (Radio Subsystem of Scanner 1300) |
| 1400 | Management/Point-Of-Sale (POS) Tablet |
| 1401 | Radio-SS (Radio Subsystem of Tablet 1400) |
| 1404 | Display (of Tablet 1400) |
| 1405 | Buttons (of Tablet 1400) |
| 1406 | NV Storage (of Tablet 1400) |
| 1407 | Program Storage |
| 1410 | Database Storage (of Tablet 1400) |
| 1500 | Mobile or Wearable |
| 1501 | Radio-SS (Radio Subsystem of Mobile or Wearable 1500) |
| 1502 | NFC-Engine (of Mobile or Wearable 1500) |
| 1503 | NFC NVM |
| 1504 | Display (of Mobile or Wearable 1500) |
| 1505 | Buttons (of Mobile or Wearable 1500) |
| 1506 | NV Storage (of Mobile or Wearable 1500) |
| 1600 | Private LAN |
| 1601 | Private WiFi Hot Spot/Router |
| 1605 | Private Local Server |
| 1610 | Database Storage (of Server 1605) |
| 1700 | Internet |
| 1701 | Public WiFi Hot Spot/Router |
| 1705 | Private Remote Server |
| 1710 | Database Storage (of Server 1705) |
| 1750 | Off-site |
| 1800 | Coupon or Card |
| 1803 | NFC Tag |
| 1804 | Static QR Code |
| 1805 | Contactless SmartCard Chip |
| 2000 | Timing |
| 2001 | Interval 1 |
| 2002 | Interval 2 |
| 2003 | Interval 3 |
| 2004 | Interval 4 |
| 2010 | Beacon Activity |
| 2011 | Advertising Data (of Interval 1) |
| 2012 | Advertising Data (of Interval 2) |
| 2013 | Advertising Data (of Interval 3) |
| 2014 | Advertising Data (of Interval 4) |
| 2020 | Other Base Activity |
| 2021 | Notify Host |
| 2022 | NFC Config. (Configure) |
| 2023 | Tap Event |
| 2024 | NFC “Read” |
| 2030 | Mobile BLE GAP Activity |
| 2031 | Scan Response Data |
| 2040 | Mobile In-Range-of-Beacon State |
| 2050 | Mobile Loyalty-App-Active State |
| 2060 | Mobile Target-Ready (NFC Tag or Barcode) State |
| 2080 | Mobile QR Code in-Scan-Zone State |
| 2090 | Host (Terminal Manager) Activity |
| 2091 | Scanner Config. (Configure) |
| 2100 | Scanner Activity |
| 2101 | Good Decode |

### Detailed Description

A detailed description of one or more embodiments of the invention is provided below along with accompanying figures illustrating selected details of the invention. The invention is described in connection with the embodiments. The embodiments herein are understood to be merely exemplary, the invention is expressly not limited to or by any or all of the embodiments herein, and the invention encompasses numerous alternatives, modifications, and equivalents. To avoid monotony in the exposition, a variety of word labels (including but not limited to: first, last, certain, various, further, other, particular, select, some, and notable) may be applied to separate sets of embodiments; as used herein such labels are expressly not meant to convey quality, or any form of preference or prejudice, but merely to conveniently distinguish among the separate sets. The order of some operations of disclosed processes is alterable within the scope of the invention. Wherever multiple embodiments serve to describe variations in process, method, and/or program instruction features, other embodiments are contemplated that in accordance with a predetermined or a dynamically determined criterion perform static and/or dynamic selection of one of a plurality of modes of operation corresponding respectively to a plurality of the multiple embodiments. Numerous specific details are set forth in the following description to provide a thorough understanding of the invention. The details are provided for the purpose of example and the invention may be practiced according to the claims without some or all of the details. For the purpose of clarity, technical material that is known in the technical fields related to the invention has not been described in detail so that the invention is not unnecessarily obscured.

### Introduction

This introduction is included only to facilitate the more rapid understanding of the Detailed Description; the invention is not limited to the concepts presented in the introduction (including explicit examples, if any), as the paragraphs of any introduction are necessarily an abridged view of the entire subject and are not meant to be an exhaustive or restrictive description. For example, the introduction that follows provides overview information limited by space and organization to only certain embodiments. There are many other embodiments, including those to which claims will ultimately be drawn, discussed throughout the balance of the specification.

At least some of the various shorthand abbreviations (e.g. acronyms) listed following refer to certain elements referenced herein.

| | |
|---|---|
| AC | Alternating Current |
| BLE | BLuetooth Low Energy |
| DC | Direct Current |
| DVI | Digital Visual Interface |
| EMV | Europay MasterCard Visa |
| GAP | Generic Access Profile |
| HDMI | High Definition Multimedia Interface |
| I/F | InterFace |
| I/O | Input/Output |
| ID | IDentification |
| LAN | Local Area Network |
| LED | Light Emitting Diode |
| NFC | Near Field Communication |
| NV | Non-Volatile |
| NVM | Non-Volatile Memory |
| QR | Quick Response |
| UI | User Interface |
| USB | Universal Serial Bus |
| VGA | Video Graphics Adapter |

### Example Embodiments

In concluding the introduction to the detailed description, what follows is a collection of example embodiments, including at least some explicitly enumerated as “ECs” (Example Combinations), providing additional description of a variety of embodiment types in accordance with the concepts described herein; these examples are not meant to be mutually exclusive, exhaustive, or restrictive; and the invention is not limited to these example embodiments but rather encompasses all possible modifications and variations within the scope of the issued claims.
EC1) A method comprising:
preinstalling a customer loyalty app on a mobile device;
transmitting advertising data by a beacon;
in accordance with predetermined data broadcast by the beacon, activating the customer
loyalty app;
preparing a scan target by the activated customer loyalty app; and
using a scanning subsystem to read the scan target to confirm a customer transaction.
EC2) The method of EC1, wherein the scan target is readable by NFC techniques.
EC3) The method of EC1, wherein the scan target is readable by optical scanning techniques.
EC4) The method of EC1, wherein the scan target is readable by BLE techniques.
EC5) The method of EC1, wherein the activated customer loyalty app prepares and the mobile device sends scan response data to configure the scanning subsystem for optimal scanning.
EC6) The method of EC1, wherein the beacon and the scanning subsystem are comprised in a single terminal.
EC7) The method of EC6, wherein the scanning subsystem comprises NFC and optical scanning engines for scanning scan targets of either type.
EC8) The method of EC1, wherein the scanning subsystem is comprised in a first physical element and the beacon is comprised in a second physical element.
EC9) The method of EC1, wherein the beacon and the mobile device are BLE compliant.
EC10) A method comprising:
preinstalling a customer loyalty app on a mobile device;
transmitting advertising data by a beacon;
in accordance with predetermined data broadcast by the beacon, activating the customer loyalty app;
wherein the activated customer loyalty app prepares and the mobile device sends scan response data to an NFC-Engine subsystem; and
using the scan response data to confirm a customer transaction.
EC11) The method of EC10, wherein the beacon, the NFC-Engine subsystem, and the mobile device are BLE compliant.
EC12) A method comprising:
transmitting a beacon comprising advertising data, the advertising data being in accordance with a customer loyalty app installed on one or more mobile devices;
scanning a scan target determined by an activation of the customer loyalty app on a particular one of the mobile devices, the activation being responsive to at least a portion of the advertising data; and
confirming a customer transaction based on information obtained from the scan target by the scanning.
EC13) The method of EC12, wherein the transmitting is performed by a beacon transmitting subsystem, the scanning is performed by a scanning subsystem, and the beacon transmitting subsystem and the scanning subsystem are comprised in a single terminal.
EC14) The method of EC12, wherein the transmitting is performed by a beacon transmitting subsystem comprised in a first physical element and the scanning is performed by a scanning subsystem comprised in a second physical element.
EC15) The method of EC12, wherein the transmitting is via a BLE technique.
EC16) A method comprising:
in a mobile device, receiving a beacon comprising advertising data, the advertising data being in accordance with a customer loyalty app installed on the mobile device;
in the mobile device and responsive to at least a portion of the advertising data, activating the customer loyalty app to determine a scan target; and
providing the scan target to confirm a customer transaction via scanning the scan target.
EC17) The method of EC12 or EC16, wherein the scanning is optical and the scan target is a barcode presented on a visual display of the (particular) mobile device.
EC18) The method of EC17, wherein the barcode comprises a QR code.
EC19) The method of EC12 or EC16, wherein the scanning is performed by a scanning subsystem and further comprising configuring the scanning subsystem for optimal scanning responsive to configuration information provided by the activated customer loyalty app.
EC20) The method of EC12 or EC16, wherein the scanning is via an NFC technique and the scan target is an NFC target provided by an NFC engine of the (particular) mobile device.
EC21) The method of EC12 or EC16, wherein the scanning is via a BLE technique and the scan target is a BLE communication provided by a BLE radio of the (particular) mobile device.
EC22) The method of EC12 or EC16, wherein the scanning is performed by a scanning subsystem enabled to selectively scan either of optical targets and NFC targets.
EC23) The method of EC12 or EC16, wherein the (particular) mobile device is at least one of a smartphone and a tablet.
EC24) The method of EC12 or EC16, wherein the (particular) mobile device is at least one of a coupon and a card.
EC25) The method of EC12 or EC16, wherein the (particular) mobile device is wearable.
EC26) The method of EC25, wherein the (particular) mobile device is one or more of a watch, a fitness band, and a wristband.
EC27) The method of EC25, wherein the (particular) mobile device is jewelry.
EC28) The method of EC27, wherein the jewelry is one or more of a ring, a bracelet, and a necklace.
EC29) An apparatus comprising:
a transmitter enabled to transmit a beacon comprising advertising data, the advertising data being in accordance with a customer loyalty app installed on one or more mobile devices; and
a scanning subsystem enabled to scan a scan target determined by an activation of the customer loyalty app on a particular one of the mobile devices, the activation being responsive to at least a portion of the advertising data, and wherein the scan target comprises information to enable confirming a customer transaction.
EC30) The apparatus of EC29, wherein the scanning subsystem is optical and the scan target is a barcode presented on a visual display of the particular mobile device.
EC31) The apparatus of EC30, wherein the barcode comprises a QR code.
EC32) The apparatus of EC29, further comprising configuring the scanning subsystem for optimal scanning responsive to configuration information provided by the activated customer loyalty app.
EC33) The apparatus of EC29, wherein the scanning subsystem is an NFC scanning subsystem and the scan target is an NFC target provided by an NFC engine of the particular mobile device.
EC34) The apparatus of EC29, wherein the scanning subsystem is a BLE scanning subsystem and the scan target is a BLE communication provided by a BLE radio of the particular mobile device.
EC35) The apparatus of EC29, wherein the scanning subsystem comprises an optical scanning subsystem and an NFC scanning subsystem, enabling the apparatus to selectively scan either of optical targets and NFC targets.
EC36) The apparatus of EC29, wherein the transmitter and the scanning subsystem are comprised in a single terminal.
EC37) The apparatus of EC29, wherein the transmitter is comprised in a first physical element and the scanning subsystem comprised in a second physical element.
EC38) The apparatus of EC29, wherein the transmitter comprises a BLE radio.
EC39) The apparatus of EC29, wherein the particular mobile device is at least one of a smartphone and a tablet.
EC40) The apparatus of EC29, wherein the particular mobile device is at least one of a coupon and a card.
EC41) The apparatus of EC29, wherein the particular mobile device is wearable.
EC42) The apparatus of EC41, wherein the particular mobile device is one or more of a watch, a fitness band, and a wristband.
EC43) The apparatus of EC41, wherein the particular mobile device is jewelry.
EC44) The apparatus of EC43, wherein the jewelry is one or more of a ring, a bracelet, and a necklace.
EC45) A system comprising:
means for transmitting a beacon comprising advertising data, the advertising data being in accordance with a customer loyalty app installed on one or more mobile devices; and
means for scanning a scan target determined by an activation of the customer loyalty app on a particular one of the mobile devices, the activation being responsive to at least a portion of the advertising data, and wherein the scan target comprises information to enable confirming a customer transaction.
EC46) The system of EC45, wherein the means for transmitting and the means for scanning are comprised in a single terminal.
EC47) The system of EC45, wherein the means for transmitting is comprised in a first physical element and the means for scanning is comprised in a second physical element.
EC48) A system comprising:
means for receiving a beacon comprising advertising data, the advertising data being in accordance with a customer loyalty app installed on a mobile device;
means for activating the customer loyalty app to determine a scan target, the means for activating being responsive to at least a portion of the advertising data;
means for providing the scan target to confirm a customer transaction via scanning the scan target; and
wherein the means for receiving, the means for activating, and the means for providing are comprised in the mobile device.
EC49) The system of EC45 or EC48, wherein the scanning is optical and the scan target is a barcode presented on a visual display of the (particular) mobile device.
EC50) The system of EC49, wherein the barcode comprises a QR code.
EC51) The system of EC45 or EC48, wherein the scanning is via an NFC technique and the scan target is an NFC target provided by an NFC engine of the (particular) mobile device.
EC52) The system of EC45 or EC48, wherein the scanning is via a BLE technique and the scan target is a BLE communication provided by a BLE radio of the (particular) mobile device.
EC53) The system of EC45 or EC48, wherein the scanning comprises selectively scanning either of optical targets and NFC targets.
EC54) The system of EC45 or EC48, wherein the beacon is communicated via a BLE technique.
EC55) The system of EC45 or EC48, wherein the (particular) mobile device is at least one of a smartphone and a tablet.
EC56) The system of EC45 or EC48, wherein the (particular) mobile device is at least one of a coupon and a card.
EC57) The system of EC45 or EC48, wherein the (particular) mobile device is wearable.
EC58) The system of EC57, wherein the (particular) mobile device is one or more of a watch, a fitness band, and a wristband.
EC59) The system of EC57, wherein the (particular) mobile device is jewelry.
EC60) The system of EC59, wherein the jewelry is one or more of a ring, a bracelet, and a necklace.
EC61) A mobile device comprising:
a receiver enabled to receive a beacon comprising advertising data, the advertising data being in accordance with a customer loyalty app installed on the mobile device; and
an optical display enabled to present a scan target determined by the customer loyalty app as activated by and responsive to at least a portion of the advertising data, and wherein the scan target comprises information to enable confirming a customer transaction.
EC62) The mobile device of EC61, wherein the scan target comprises a barcode.
EC63) The mobile device of EC62, wherein the barcode comprises a QR code.
EC64) A mobile device comprising:
a receiver enabled to receive a beacon comprising advertising data, the advertising data being in accordance with a customer loyalty app installed on the mobile device; and
an NFC subsystem enabled to provide a scan target determined by the customer loyalty app as activated by and responsive to at least a portion of the advertising data, and wherein the scan target comprises information to enable confirming a customer transaction.
EC65) The mobile device of EC61 or EC64, wherein the receiver comprises a BLE radio.
EC66) The mobile device of EC61 or EC64, wherein the mobile device is at least one of a smartphone and a tablet.
EC67) The mobile device of EC61 or EC64, wherein the mobile device is at least one of a coupon and a card.
EC68) The mobile device of EC61 or EC64, wherein the mobile device is wearable.
EC69) The mobile device of EC68, wherein the mobile device is one or more of a watch, a fitness band, and a wristband.
EC70) The mobile device of EC68, wherein the mobile device is jewelry.
EC71) The mobile device of EC70, wherein the jewelry is one or more of a ring, a bracelet, and a necklace.

### Customer Loyalty Terminal—Structural Perspective

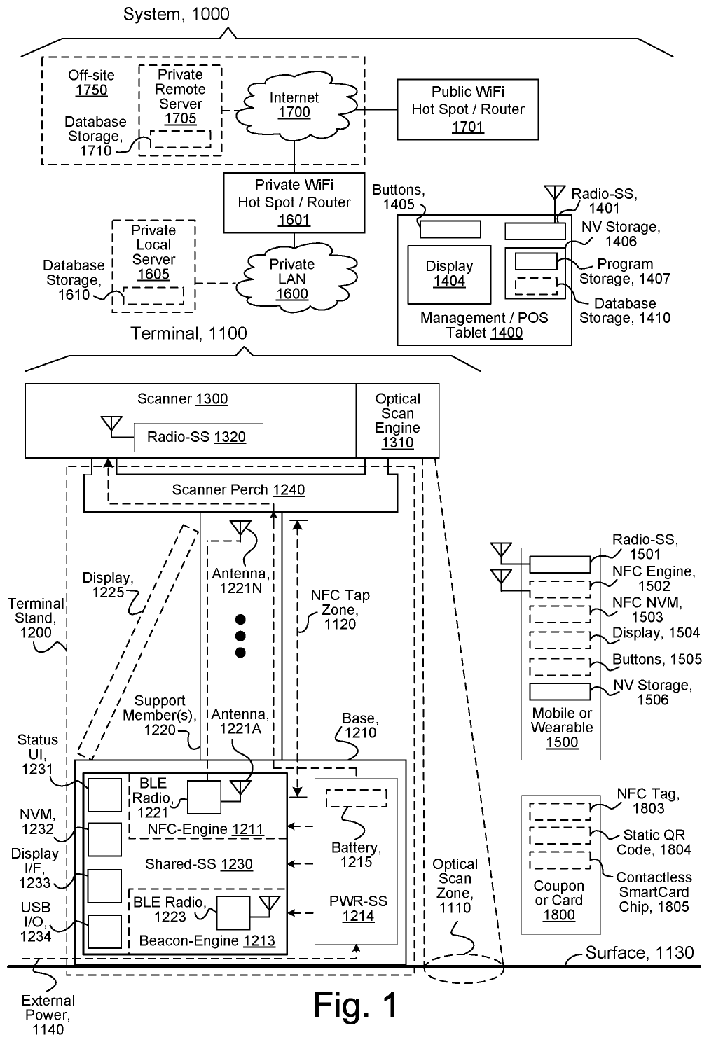

FIG. 1 illustrates, via a structural perspective, embodiments for the beacon-activated automatic generation of scan targets and scan responses, as System 1000. In some embodiments, a system comprises Terminal 1100 (in various featured configurations as described below), Management/Point-Of-Sale Tablet 1400 (or equivalent host), and Customer devices, such as a Mobile or Wearable device 1500, and/or Coupon or Card 1800.

In some embodiments, Terminal 1100 comprises Terminal Stand 1200 and Scanner 1300. Terminal Stand 1200 comprises Base 1210, and according to embodiment further comprises Support Member(s) 1220, and Scanner Perch 1240, providing a raised platform for captive and generally hands-free use of Scanner 1300. Scanner Perch 1240 is enabled to position, retain, and provide power to Scanner 1300, enabling Optical Scan Engine 1310 to decode optical scan targets (including but not limited to QR Codes and Linear barcodes) placed within Optical Scan Zone 1110 on Surface 1130. Support Member(s) 1220 comprises, according to embodiment, one or more posts, columns, structural frameworks, articulating arms, or other elements to correspondingly position/suspend Scanner Perch 1240, and thereby Scanner 1300 when present, with respect to Optical Scan Zone 1110.

In some embodiments, Scanner 1300 is a cordless hand scanner, removable from Terminal Stand 1200, optimized to operatively scan optical targets while being wielded by one hand, and comprises Optical Scan Engine 1310 and Radio Subsystem 1320. In some embodiments, Radio Subsystem 1320 comprises a (Classic) BlueTooth Radio enabled to communicate with Management/Point-Of-Sale Tablet 1400 for receiving configuration commands and for communication of, and status about, decoded QR Codes and various other types of barcodes. In some embodiments, Scanner 1300 is integral to Terminal Stand 1200 and is not removable.

Base 1210 rests on (generally planar and level) Surface 1130 and comprises Power Subsystem 1214, NFC-Engine 1211, Shared Subsystem 1230, and Beacon-Engine 1213. Base 1210 does not require Scanner 1300 to carry out non-optical-scanning tasks. In some embodiments, Base 1210 is installed and setup by itself and without Scanner 1300, Scanner Perch 1240, or Support Member(s) 1220. In some embodiments, Scanner 1300 is fastened to Scanner Perch 1240 and Base 1210 is implemented separately from other elements of Terminal 1100, e.g., in or for placement on a countertop. Thus, according to embodiment, references herein to Terminal 1100, are variously with respect to only Base 1210, or to the combination of Base 1210 with Scanner 1300, the latter in various embodiments held by Scanner Perch 1240 atop Support Member(s) 1220.

NFC-Engine 1211 includes BLE Radio 1221, and at least Antenna 1221A. Beacon-Engine 1213 includes BLE Radio 1223, that according to embodiment is capable of sending Beacon information (such as to Radio Subsystem 1501). Shared Subsystem 1230 comprises functionality that is shared between NFC-Engine 1211 and Beacon-Engine 1213, including Status UI 1231, NVM 1232, Display Interface 1233, and USB I/O 1234. In some embodiments, Shared Subsystem 1230 further comprises a shared BLE Radio replacing the individual BLE Radios of NFC-Engine 1211 and Beacon-Engine 1213.

Status UI 1231 provides one or more of LED, tone, and vibration status indicators. The LED indicators comprise Power, BlueTooth, NFC Read, and Scanner Status. In some embodiments, NVM 1232 provides respective portions of a physically shared nonvolatile memory for each of the NFC-Engine and the Beacon-Engine for their programs and data. In some embodiments, each of the NFC-Engine and the Beacon-Engine have respective physically separate nonvolatile memories. Display Interface 1233 provides an industry-standard output for an external display (according to embodiment, one or more of DisplayPort, mini DisplayPort, HDMI, mini HDMI, VGA, or DVI). USB I/O 1234 provides (in accordance with at least one version of the USB specification) diagnostic and configuration access, including to NVM 1232 for firmware updates, and enables select external UI devices to be connected. In various embodiments, one or more of the functionalities provided by the USB I/O are provided via BLE Radio 1221 and/or BLE Radio 1223. In some embodiments, USB I/O 1234 is omitted. Display 1225 (shown in FIG. 1 in a side/profile view, with the screen facing upward and to the left) is provided in some embodiments as a second screen to that of Management/Point-Of-Sale Tablet 1400.

Power Subsystem 1214 is sourced power from External Power 1140. In some embodiments, an external “power-brick” provides External Power 1140 as regulated DC power suitable for direct distribution to NFC-Engine 1211, Shared Subsystem 1230, Beacon-Engine 1213, and Scanner 1300 when the latter is present. In some embodiments, External Power 1140 is AC-mains power, and Power Subsystem 1214 comprises DC regulation as appropriate for each downstream subsystem. In some embodiments, Power Subsystem 1214 includes Battery 1215. In some embodiments, Battery 1215 is rechargeable and Power Subsystem 1214 comprises battery-charging circuitry.

Management/Point-Of-Sale Tablet 1400 comprises Radio Subsystem 1401, Buttons 1405, Display 1404, Nonvolatile storage 1406, Program Storage 1407, and according to embodiment Database Storage 1410. In some embodiments, Management/Point-Of-Sale Tablet 1400 is an Apple iPad running inter alia a Point-Of-Sale (POS) application on top of an Apple IOS operating system. In some embodiments, Management/Point-Of-Sale Tablet 1400 is an Android-compatible device (such as a tablet) running inter alia a Point-Of-Sale (POS) application on top of an Android operating system. In some embodiments, Management/Point-Of-Sale Tablet 1400 is a Windows-compatible device (such as a tablet) running inter alia a Point-Of-Sale (POS) application on top of a Windows operating system. In some embodiments, Radio Subsystem 1401 comprises a WiFi radio and a dual-mode Classic/BLE Bluetooth radio. In some embodiments, the Classic mode radio is used for communications with Scanner 1300 and the BLE mode is used for communications with NFC-Engine 1211 and Beacon-Engine 1213. In some embodiments, the WiFi radio is to communicate via Private WiFi Hot Spot/Router 1601 and Private LAN 1600 with Private Local Server 1605 to access Database Storage 1610. In some embodiments having one or more elements of Off-site 1750, Tablet 1400 optionally also communicate via Internet 1700 with Private Remote Server 1705 to access Database Storage 1710. The various Database Storage instances 1410, 1610, and 1710, are optionally used according to embodiment for one or more of syncing, backup, or caching of database subsets, in accordance with well-known methods.

Mobile or Wearable 1500 is intended to represent one of either a mobile device (such as a smartphone, or tablet, generally having a display) or a wearable device (such as a watch or fitness band, having a small or no display according to embodiment). According to embodiment, Mobile or Wearable 1500 comprises one or more of Radio Subsystem 1501, NFC Engine 1502, NFC NVM 1503, Display 1504, Buttons 1505, and NV Storage 1506. In some embodiments, Mobile or Wearable 1500 is a selected one of an IOS smartphone, an Android smartphone, a Windows smartphone, a BlackBerry smartphone, an Apple Watch, a Sony Smartwatch, or an NFC smart wristband, ring, bracelet, necklace, or other jewelry. According to embodiment, Radio Subsystem 1501 is enabled to receive Beacon information (such as from BLE Radio 1223) via, e.g., an included Bluetooth/BLE capability. According to embodiment, mobile devices optionally and/or selectively connect to Internet 1700 either via an integral cellular connection or via Public WiFi Hot Spot/Router 1701. Access to the Public Hot Spot is variously unrestricted, provided as a general customer courtesy, or selectively provided as part of a customer loyalty program (for example, to those Customers that have installed the customer loyalty application, or have met other predetermined customer loyalty criteria), according to embodiment and/or usage scenario.

Coupon or Card 1800 is intended to represent one of either a generally credit-card sized electronic identity card (frequently used for access, transit, and banking) or a printed-paper coupon. According to embodiment, Coupon or Card 1800 comprises one or more of NFC Tag 1803, Static QR Code 1804, or Contactless SmartCard Chip 1805. In some embodiments, Coupon or Card 1800 is a selected one of an NFC Loyalty Card, a printed coupon, a QR Code Loyalty Card, or an Oyster Card.

### Customer Loyalty Terminal—Temporal Perspective

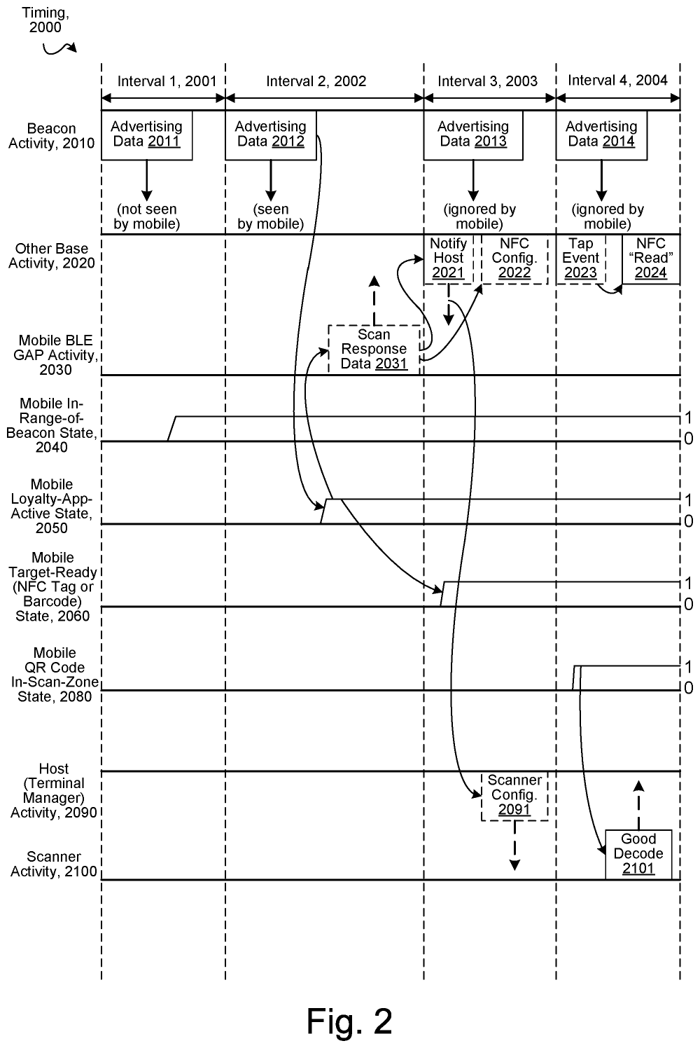

FIG. 2 illustrates, via a temporal perspective, activities, states, and interrelationships between various components of the system of FIG. 1, and in accordance with a particular scenario for a particular mobile (or wearable) device. As illustrated according to Timing 2000, time passes (increases) conventionally from left-to-right in FIG. 2, separated into four contiguous time intervals (Interval 1 2001, Interval 2 2002, Interval 3 2003, and Interval 4 2004), each interval spanning FIG. 2 from top to bottom. The intervals are overlaid by multiple horizontal rows, each row representing the activity or state of a particular component. Causality arrows show the interrelationship between various component activities and states. The intervals are meant to be suggestive of the relative passage of time between the various components. It should not be inferred that the intervals necessarily correspond to any particular amount of time, that the respective intervals are drawn to a common scale, or that the inter-interval or intra-interval passage of time is linearly represented.

Beacon Activity 2010 comprises the broadcast of Beacon information, such as so-called Advertising Data 2011 through Advertising Data 2014, respectively in each of the intervals. The downward arrows are intended to conceptually suggest that the broadcasts are sent toward other devices represented lower in the diagram. The parentheticals adjacent to the downward arrows are intended to respectively indicate whether each broadcast is seen, not seen, or ignored by a particular mobile device, in accordance to the scenario portrayed.

The particular mobile device of the scenario first comes in-range of the Beacon, and then stays in range of the Beacon for the remainder of FIG. 2, as illustrated by Mobile In-Range-of-Beacon State 2040. Accordingly, the first Beacon broadcast (Advertising Data 2011) is not seen by the particular mobile, the second Beacon broadcast (Advertising Data 2012) is seen and acted upon, while the other Beacon broadcasts (Advertising Data 2013 and Advertising Data 2014) are ignored by the particular mobile for the duration of the scenario. Other mobiles will have their own temporal perspective, behaving independently of the particular mobile described in the instant scenario. Limited only by resource contention for scanning codes and reading tags, from a human perspective Terminal 1100 is enabled to interact with multiple mobiles or wearables concurrently in readying respective mobile scan targets.

As a result of recognizing the second Beacon broadcast (Advertising Data 2012) as being associated with a corresponding pre-installed software application (also known as a customer loyalty app.), the application is subsequently activated in Interval 2 2002, as illustrated by Mobile Loyalty-App-Active State 2050. The now activated customer loyalty app subsequently readies a scan target (for subsequent presentation at the terminal), as portrayed by Mobile Target-Ready (NFC Tag or Barcode) State 2060. The scan target is a custom dynamically generated NFC tag, QR Code, or other scan target, according to embodiment and configuration. In some embodiments, the scan target comprises data derived from one or more of location context provided by the Beacon payload, the mobile user's ID, and the mobile user's transaction guidance. The transaction guidance comprises selecting one or more predetermined transaction types or attributes (including but not limited to, a payment, a normal purchase, a purchase based on a standard loyalty program discount, a purchase with a special discount, a return, will-call or other pickup, placing a special order, use of cash, use of store credit, use of a credit card, use of a gift card, use of an electronic payment method, request for a printed receipt, request for an email receipt, sharing purchases to social media, “likes” or the equivalent to social media in exchange for an offered discount, spontaneous “likes”, requesting an appointment, cancelling an appointment, rescheduling an appointment, checking-in for an appointment, making a suggestion, submitting a complaint, performing a price-check, performing an in-stock check, inquiring about a lost item, submitting a found item, requesting in-store directions, or requesting directions to places and services in the nearby vicinity) or otherwise sending a custom request or other message to a particular department.

The customer confirms the transaction by presenting their readied scan target at the terminal. For optical scan targets, the confirmation corresponds to placing the mobile device, wearable, coupon, or card, with the scan target upward and otherwise visible within Optical Scan Zone 1110, as represented by Mobile QR Code in-Scan-Zone State 2080. In some embodiments, Display 1504 displays the scan target and for confirmation is made visible within Optical Scan Zone 1110. In some embodiments, Scanner 1330 is placed into “presentation mode” of continuously attempting to decode, awaiting the presentation of a valid code. Scanner Activity 2100 shows event Good Decode 2101 subsequent to the scan target being appropriately placed as described previously. The upward arrow of Good Decode 2101 event conceptually represents the communication of the event and the decoded barcode to Management/POS Tablet 1400 (also referred to herein as the Host, or the Terminal Manager).

For NFC scan targets, confirming the transaction corresponds to a “Tap” of the NFC tag or subsystem, such as by bringing the NFC scan target (as provided, e.g., by NFC Engine 1502) in close proximity (roughly a centimeter) to at least one of Antenna 1221A through Antenna 1221N, such as illustrated by NFC Tap Zone 1120. Providing a plurality of NFC antennas reduces the extent of customer “hunting” for where they need to place their wearable to execute a Tap. Detecting the presence of the NFC mobile device, wearable, or card, NFC-Engine 1211 proceeds to read the NFC scan target (and optionally to write the NFC scan target, in view of the NFC device presented and according to embodiment and configuration). The detection and the read are respectively represented by Tap Event 2023 and NFC “Read” 2024, both of Other Base Activity 2020. “Other” in Other Base Activity 2020, is used to distinguish from the Beacon Activity, as the Beacon also resides in the Base.

In some embodiments, for either type of scan target (optical scan or NFC), the application prepares a customized payload, broadcast by the mobile and observed by at least the terminal prior to the user's arrival at the terminal, to optimally configure terminal operation for the upcoming transaction. The customized payload is illustrated in FIG. 2 by Scan Response Data 2031, during Interval 2 of Mobile BLE GAP Activity 2030, and which is caused by the activation of the customer loyalty application. In some embodiments and according to configuration, Scan Response Data 2031 is used in lieu of (as alternative capture method) to either an NFC tap or a Barcode scan. Stated differently, the transaction confirmation information that would be conveyed in the scan target is instead conveyed entirely by Scan Response Data 2031 and there is no need for an NFC tap or a Barcode scan.

In various embodiments, Mobile or Wearable 1500 sends data to Terminal 1100 via a mechanism other than an optical scan target or an NFC scan target, such as via BLE to elements of Base 1210 or elements of Scanner 1300.

In some embodiments, such as those in which Scanner 1300 is not BLE enabled, e.g. as indicated via the customized payload, for optical scan targets Scan Response Data 2031 event results in a Notify Host 2021 event during Interval 3 2003 of Other Base Activity 2020. The Notify Host event notifies Management/POS Tablet 1400. The Management/POS Tablet in turn performs Scanner Config. 2091 during Interval 3 of Host (Terminal Manager) Activity 2090, and prior to the scan target being placed in Optical Scan Zone 1110 during Interval 4 2004, so as to optimally configure Scanner 1300 for the particular attributes of the customer's scan target. An example usage scenario of the optimally configuring is that the customer's scan target will be a QR Code on a mobile display screen (vs. a more general-purpose and thereby less optimal configuring), as detailed in Scan Response Data 2031. In some embodiments, for the duration of a mobile QR Code scan, decoding is optimized for reflective surfaces, and illumination and aiming beam functionality are turned off.

As indicated by the customized payload, for an NFC scan-target Scan Response Data 2031 event results in NFC Config. 2022 event, during Interval 3 2003 of Other Base Activity 2020. The NFC Config. event provides for an optimal configuration of NFC-Engine 1211 prior to Tap Event 2023 and NFC “Read” 2024 during Interval 4 2004. By way of illustrative but not limiting examples, Scan Response Data 2031 indicates one or more of that: the customer's scan target is comprised in a wearable, a mobile phone, has no screen, has a screen, is an NFC loyalty card, Host Card Emulation (HCE) is being used, will be compliant in accordance with a selected one of EMV, ApplePay, SamsungPay, In-app Pay, or is compliant in accordance with a selected Digital Wallet system.

### CONCLUSION

Certain choices have been made in the description merely for convenience in preparing the text and drawings and unless there is an indication to the contrary the choices should not be construed per se as conveying additional information regarding structure or operation of the embodiments described. Examples of the choices include: the particular organization or assignment of the designations used for the figure numbering and the particular organization or assignment of the element identifiers (the callouts or numerical designators, e.g.) used to identify and reference the features and elements of the embodiments.

The words “includes” or “including” are specifically intended to be construed as abstractions describing logical sets of open-ended scope and are not meant to convey physical containment unless explicitly followed by the word “within.”

Although the foregoing embodiments have been described in some detail for purposes of clarity of description and understanding, the invention is not limited to the details provided. There are many embodiments of the invention. The disclosed embodiments are exemplary and not restrictive.

It will be understood that many variations in construction, arrangement, and use are possible consistent with the description, and are within the scope of the claims of the issued patent. For example, interconnect and function-unit bit-widths, clock speeds, and the type of technology used are variable according to various embodiments in each component block. The names given to interconnect and logic are merely exemplary, and should not be construed as limiting the concepts described. The order and arrangement of flowchart and flow diagram process, action, and function elements are variable according to various embodiments. Also, unless specifically stated to the contrary, value ranges specified, maximum and minimum values used, or other particular specifications (such as flash memory technology types; and the number of entries or stages in registers and buffers), are merely those of the described embodiments, are expected to track improvements and changes in implementation technology, and should not be construed as limitations.

Functionally equivalent techniques known in the art are employable instead of those described to implement various components, sub-systems, operations, functions, routines, sub-routines, in-line routines, procedures, macros, or portions thereof. It is also understood that many functional aspects of embodiments are realizable selectively in either hardware (i.e., generally dedicated circuitry) or software (i.e., via some manner of programmed controller or processor), as a function of embodiment dependent design constraints and technology trends of faster processing (facilitating migration of functions previously in hardware into software) and higher integration density (facilitating migration of functions previously in software into hardware). Specific variations in various embodiments include, but are not limited to: differences in partitioning; different form factors and configurations; use of different operating systems and other system software; use of different interface standards, network protocols, or communication links; and other variations to be expected when implementing the concepts described herein in accordance with the unique engineering and business constraints of a particular application.

The embodiments have been described with detail and environmental context well beyond that required for a minimal implementation of many aspects of the embodiments described. Those of ordinary skill in the art will recognize that some embodiments omit disclosed components or features without altering the basic cooperation among the remaining elements. It is thus understood that much of the details disclosed are not required to implement various aspects of the embodiments described. To the extent that the remaining elements are distinguishable from the prior art, components and features that are omitted are not limiting on the concepts described herein.

All such variations in design are insubstantial changes over the teachings conveyed by the described embodiments. It is also understood that the embodiments described herein have broad applicability to other computing and networking applications, and are not limited to the particular application or industry of the described embodiments. The invention is thus to be construed as including all possible modifications and variations encompassed within the scope of the claims of the issued patent.

1. (canceled)

2. A method for efficient semi-automated personalization and confirmation for in-store customer loyalty transactions, the method comprising:
broadcasting a beacon using BLE techniques by a terminal of a point-of-sale system, the terminal comprising a BLE subsystem, an optical scan subsystem, an NFC scan subsystem, and wherein the point-of-sale system and broadcast data of the beacon are associated with a particular customer loyalty program;
activating a customer loyalty application in response to recognizing the broadcast data of the beacon by a mobile device in BLE range of the terminal, the customer loyalty application being preinstalled on the mobile device of a customer and being associated with the particular customer loyalty program;
dynamically generating a customized scan target and a customized scan response by the customer loyalty application automatically in response to the beacon-activating and prior to arrival of the customer at the terminal, the dynamically generated customized scan target and dynamically generated customized scan response being for a customized customer transaction that is upcoming and pending confirmation during the generating,
wherein the dynamically generated customized scan target represents a unique and detailed electronic description of the customized customer transaction, the description comprising identification and transaction guidance of the customer, the customer transaction guidance comprising a selection from a predetermined plurality of transaction types and transaction attributes, the dynamically generated customized scan target being made ready on the mobile device by the loyalty program application for upcoming presentation by the customer to the terminal via a particular one of an optical scan capture technique and an NFC scan capture technique, and
wherein the dynamically generated scan response comprises a customized data payload broadcast using BLE techniques by the mobile device for reception by the terminal, the customized data payload comprising information about particular attributes of the dynamically generated customized scan target;
selectively configuring the terminal to optimize operation for the upcoming presentation of the dynamically generated scan target, the configuring in response to receiving the dynamically generated scan response from the mobile device and prior to the arrival of the customer at the terminal, the configuring in accordance with the particular attributes of the dynamically generated customized scan target as communicated via the received customized data payload; and
confirming the customized customer transaction as specified by the unique and detailed electronic description by the customer arriving at the terminal and presenting the ready dynamically generated customized scan target, the presenting comprising the customer placing the mobile device in a predetermined scanning zone of the terminal and in accordance with the particular one of the scan capture techniques of the dynamically generated customized scan target.

3. The method of claim 2, further comprising:
reading the dynamically generated customized scan target by a scan subsystem of the terminal in response to the presenting and in accordance with the selectively configuring, the reading comprising a receiving of the customized customer transaction by the terminal.

4. The method of claim 3, further comprising:
communicating between the terminal and a host of the point-of-sale system, the host running a point-of-sale application and managing the terminal, the communicating comprising the host selectively sending configuration commands to the terminal and the host receiving scan target data read by the scan subsystems, the scan target data received by the host comprising the customized customer transaction of the reading the dynamically generated customized scan target, the scan target data received by the host further comprising data read from any one of a plurality of types of scan targets originating from other than the customer loyalty application.

5. The method of claim 3, further comprising:
sending the customized customer transaction received by the terminal to a host of the point-of-sale system, the host running a point-of-sale application and managing the terminal.

6. The method of claim 5, further comprising:
wherein the point-of-sale system comprises respective database storage instances on the host and one or more of a private local server accessed via private LAN and a private remote server accessed via public Internet; and
the point-of-sale system selectively performs one or more of syncing, backup, and caching of database subsets across the database storage instances.

7. The method of claim 2, wherein the BLE subsystem, the optical scan subsystem, and the NFC scan subsystem are comprised in a contiguous physical element.

8. The method of claim 2, wherein the BLE subsystem and the NFC scan subsystem are comprised in a first physical element and the optical scan subsystem is comprised in a second physical element mechanically independent of the first physical element.

9. The method of claim 2, wherein the particular scan capture technique is the optical scan capture technique and the dynamically generated customized scan target is a barcode presented on a visual display of the mobile device.

10. The method of claim 9, wherein the barcode comprises a QR code.

11. The method of claim 2, wherein the particular scan capture technique is the NFC scan capture technique and the dynamically generated customized scan target is an NFC target provided by an NFC engine of the mobile device.

12. The method of claim 2, wherein the terminal is enabled to selectively scan either of optical targets and NFC targets.

13. The method of claim 2, wherein the mobile device is a particular one of a smartphone, a tablet, and a wearable.

14. The method of claim 2, wherein prior to the receiving the dynamically generated scan response the terminal is preconfigured for general purpose operation suitable for capturing at least one of a coupon and a card, the preconfiguring for general purpose operation being less optimal than the configuring in accordance with the particular attributes of the dynamically generated customized scan target.

15. The method of claim 2, further comprising:
wherein at least the BLE subsystem is comprised in a first physical element of the terminal;
wherein at least one of the scan subsystems is at least in part comprised in a second physical element of the terminal;
wherein the terminal selectively operates in a first configuration with the second physical element retained in a predetermined position by the first physical element and enabling generally hands-free operation of the at least one of the scan subsystems;
wherein the terminal selectively operates in a second configuration with the second physical element removable from the first physical element to operatively scan targets while the second physical element is wielded by one hand.

16. The system of claim 15, wherein the second physical element is a cordless hand scanner.

17. The system of claim 15, wherein the at least one of the scan subsystems is the optical scan subsystem.

18. The method of claim 9, wherein the terminal rests on a store surface and the predetermined scanning zone is a particular region on the store surface.

19. The method of claim 11, wherein the predetermined scanning zone is a predetermined physical location on the terminal for performing an NFC tap.

20. The method of claim 19, wherein the predetermined physical location is in close proximity to an antenna located in a base of the terminal.

21. The method of claim 19, wherein the predetermined physical location is in close proximity to an antenna located in a structural support for at least part of the optical scan subsystem of the terminal.

22. The method of claim 14, wherein the preconfiguration for general purpose scanning comprises turning on illumination and aiming beam functionality, the particular scan capture technique is the optical scan capture technique, and the configuring in accordance with the particular attributes of the dynamically generated customized scan target comprises turning off the illumination and aiming beam functionality during the capture of the dynamically generated customized scan target from the mobile device.

23. The method of claim 2, wherein the predetermined plurality of transaction types and transaction attributes comprises a payment, a normal purchase, a purchase based on a standard loyalty program discount, a purchase with a special discount, a return, a will-call or other pickup, placing a special order, use of cash, use of store credit, use of a credit card, use of a gift card, use of an electronic payment method, a request for a printed receipt, a request for an email receipt, sharing purchases to social media, “likes” or the equivalent to social media in exchange for an offered discount, spontaneous “likes”, requesting an appointment, cancelling an appointment, rescheduling an appointment, checking-in for an appointment, making a suggestion, submitting a complaint, performing a price-check, performing an in-stock check, inquiring about a lost item, submitting a found item, requesting in-store directions, requesting directions to places or services in the nearby vicinity, and otherwise sending a custom request or other message to a particular department.

24. The method of claim 2, wherein the terminal further has a status user interface (UI) comprising one or more of a tone status indicator, a vibration status indicator, a power status indicator LED, a Bluetooth status indicator LED, an NFC read status indicator LED, and a scanner status LED.

25. The method of claim 5, wherein each of the host and the terminal have respective displays, the host display being a first screen of the host and the terminal display being a second screen of the host.

26. The method of claim 2, wherein a change in the selection of the customer transaction guidance results in a transformation in the unique and detailed electronic description of the customized customer transaction as represented by the dynamically generated customized scan target.

27. The method of claim 10, wherein irrespective of the customer transaction guidance the QR code presented on the visual display is unique to the customer.

28. The method of claim 27, wherein a change in the selection of the customer transaction guidance results in a transformation of the unique QR code presented on the visual display.

29. The method of claim 2, wherein the dynamically generated scan response indicates that the dynamically generated customized scan target uses the NFC scan capture technique and further has the attributes of one or more of is a wearable, is a mobile phone, has no screen, has a screen, is an NFC loyalty card, is using Host Card Emulation (HCE), is EMV compliant, is ApplePay compliant, is SamsungPay compliant, is In-app Pay compliant, and is compliant with a Digital Wallet system.
